(19) United States
(12) Patent Application Publication
(10) Pub. No.: US 2025/0043066 A1
(43) Pub. Date: Feb. 6, 2025

(54) AMINE COMPOSITION, EPOXY SYSTEM PREPARED FROM THE AMINE COMPOSITION AND AN EPOXY RESIN, AND USE OF THE EPOXY SYSTEM

(71) Applicant: EVONIK OPERATIONS GMBH, Essen (DE)

(72) Inventors: Qiubai PENG, Shanghai (CN); Shuanghu LI, Shanghai (CN)

(73) Assignee: EVONIK OPERATIONS GMBH, Essen (DE)

(21) Appl. No.: 18/292,828

(22) PCT Filed: Aug. 5, 2021
(86) PCT No.: PCT/CN2021/110983

§ 371 Date: Jan. 26, 2024

(51) Int. Cl. C08G 59/56; C08G 59/22; C08G 59/24; C08G 59/50; C08G 59/62

(52) U.S. Cl. CPC C08G 59/56; C08G 59/226; C08G 59/245; C08G 59/502; C08G 59/5026; C08G 59/623; C08G 2650/50

(57) ABSTRACT

The present disclosure relates to an amine composition comprising a) an alkylated diamine b) a tertiary amine; and c) a polyoxyalkyleneamnne. Also disclosed are an epoxy system prepared from the amine composition and an epoxy resin and use thereof.

### FIELD OF THE DISCLOSURE

The present disclosure relates to an amine composition, and further to an epoxy system prepared from the amine composition and an epoxy resin and usage thereof.

### BACKGROUND

The wind energy industry needs large wind turbine blades for power generation. A blade usually consists of two parts which are bonded together with an epoxy adhesive. To make wind turbine blades, a resin infusion process is usually employed. In that process, fibers are placed in molds and epoxy resin is injected into the mold cavity under pressure. After the epoxy resin fills all the space between fibers, the component is cured by heat. The resin injection could happen under pressure higher than the ambient pressure, or under vacuum or pressure lower than the ambient pressure.

One requirement of the epoxy system is a longer pot life to wet fibers in sections of the parts. In thick sections, the fabric layers are very tight under vacuum or pressure and the resin cannot easily penetrate fabric layers. If temperature raises during processing, viscosity of the epoxy system will increase, making wetting of fibers difficult and resulting in mechanical property loss in the fabricated parts. As the parts become larger in dimension, viscosity of the adhesive needs to be lowered to achieve good wetting of reinforcing fillers. Epoxy systems suitable for composite processing are expected to have an initial viscosity low enough and a rate of viscosity increase at the impregnation temperature low enough to enable the reinforcing fiber preform to be completely wetted with epoxy resin before the epoxy system becomes too viscous.

Another requirement is fast development of glass transition temperature (T_{g}) for epoxy systems. Epoxy systems used for fabricating wind turbine blades are expected to reach a T_{g} of at least 70° C. in a mold held at 70° C.. Fast T_{g} development is highly desired since the fast development enables the parts to be removed from the mold sooner and thereby reduces cycling time, improving productivity in a given amount of time.

One other requirement is reduced exothermic effect during curing of the epoxy system cure. In thicker sections of the parts, the heat released during curing cannot be easily dissipated. If excessive temperatures are reached during the curing process, thermal degradation of the cured resin can occur and result in loss of mechanical properties in the fabricated blades.

Thus, the industry requires an epoxy resin system, which has an extended pot life, a fast development of glass transition temperature, and a reduced exothermic effect during curing process.

### SUMMARY

Generally, epoxy systems for windmill blade fabrication must meet certain cured mechanical property requirements such as a minimum tensile strength of 55 MPa, a minimum tensile modulus of 2,700 MPa, a minimum tensile elongation of 2.5%, a minimum flexural strength of 100 MPa and a minimum flexural modulus of 2,700 MPa.

In light of the above requirements, there is a need in the art for improved curing agents/hardeners for producing epoxy resin systems which have a long pot life, fast T_{g} development and reduced exothermic effect while maintaining desired mechanical properties and good processing properties when compared to known compositions.

One objective of the present disclosure is to provide an amine composition, which, when combined with epoxy resin, can form an epoxy system with a long pot life, a fast development of curing process, and a reduced exothermal effect.

This objective of the present disclosure is achieved by an amine composition comprising a) an alkylated diamine; b) a tertiary amine; and c) a polyoxyalkyleneamine.

Preferably, the alkylated diamine includes one or more selected from a mono-alkylated isophorone diamine, a di-alkylated isophorone diamine, a mono-alkylated cyclohexyldiamine, a di-alkylated cyclohexyldiamine, a mono-alkylated alkylcyclohexyldiamine, a di-alkylated alkylcyclohexyldiamine, a mono-alkylated 4-4′-methylenebis(cyclohexylamine), a di-alkylated 4-4′-methylenebis(cyclohexylamine), a mono-alkylated xylylenediamine, a di-alkylated xylylenediamine, a mono-alkylated bis(aminomethyl)cyclohexane, or a di-alkylated bis(aminomethyl)cyclohexane.

Preferably, the tertiary amine includes a phenolic tertiary amine.

Preferably, the polyoxyalkyleneamine includes at least one amino-terminated polyoxyethylene, amino-terminated polyoxypropylene, or amino-terminated polyoxybutylene.

Preferably, the polyoxyalkyleneamine includes an amino-terminated polyoxypropylene.

Preferably, the polyoxyalkyleneamine includes

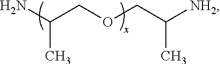

wherein x is an integer ranging from 2 to 70.

Preferably, the amine composition further comprises a cycloaliphatic amine.

More preferably, the cycloaliphatic amine includes one or more selected from the group consisting of isophorone diamine, methylcyclohexyldiamine, cyclohexyldiamine, 4,4′-methylenebis(cyclohexylamine), isomers of xylylenediamine, 1,2-bis aminomethylcyclohexane, 1,3-bis aminomethylcyclohexane, or 1,4-bis aminomethylcyclohexane.

Another objective of the present disclosure is to provide an epoxy system prepared from the amine composition and an epoxy resin.

Preferably, the epoxy resin includes one or more glycidyl ethers selected from the group of glycidyl ethers of: resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane, bis-(4-hydroxyphenyl)-methane, any of C12 to C14 alcohols, butanediol, hexanediol, polyoxypropylene glycol, and any combination thereof.

Preferably, the amine composition has a weight percentage of 10% to 40%, and the epoxy resin has a weight percentage of 60% to 90%, based on a total weight of the epoxy system.

Preferably, the epoxy system further comprises one or more additives selected from the group consisting of fillers, reinforcing agents, coupling agents, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, adhesion promoters, anti-dripping agents, metallic pigments, stabilizers, metal glitters, metal coated particles, porosity inducers, plasticizers, glass fibers, nanoparticles, or flow assistants.

Preferably, a stoichiometric ratio of the amine composition to the epoxy resin is 0.5 to 1.5, more preferably 0.7 to 1.2, still more preferably 0.8 to 1.0.

Another objective of the present disclosure is to provide a usage of the epoxy system for producing structural or electrical laminates, coatings, castings, structural components, circuit boards, electrical varnishes, encapsulants, semiconductors, general molding powders, filament wound pipes and fittings, filament wound pressure vessels, low and high pressure pipes and fittings, low and high pressure vessels, storage tanks, wind turbine blades, automotive structural parts, aerospace structural parts, oil and gas buoyance modules, rigs, well plugs, cure-in-place-pipe (CIPP), structural bonding adhesives and laminates, a composite liner, liners for pumps, corrosion resistant coatings or composite materials based on reinforced fiber substrates.

### BRIEF DESCRIPTION OF THE DRAWINGS

FIG. 1 illustrates change of viscosity of the examples over time.

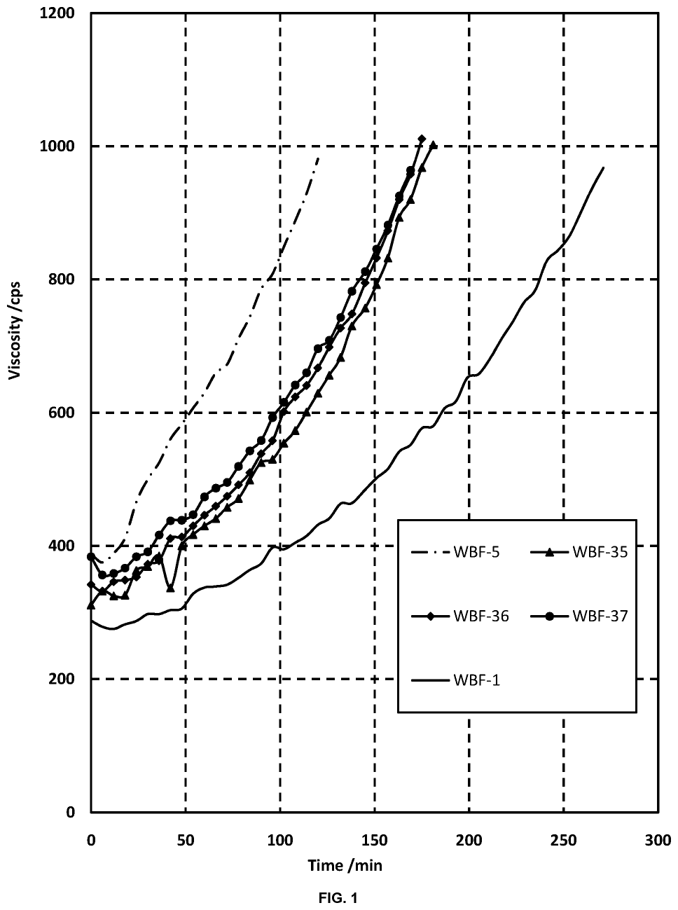

FIG. 2 illustrates development of glass transition temperature of the examples overtime after the examples were cured for 1 hour.

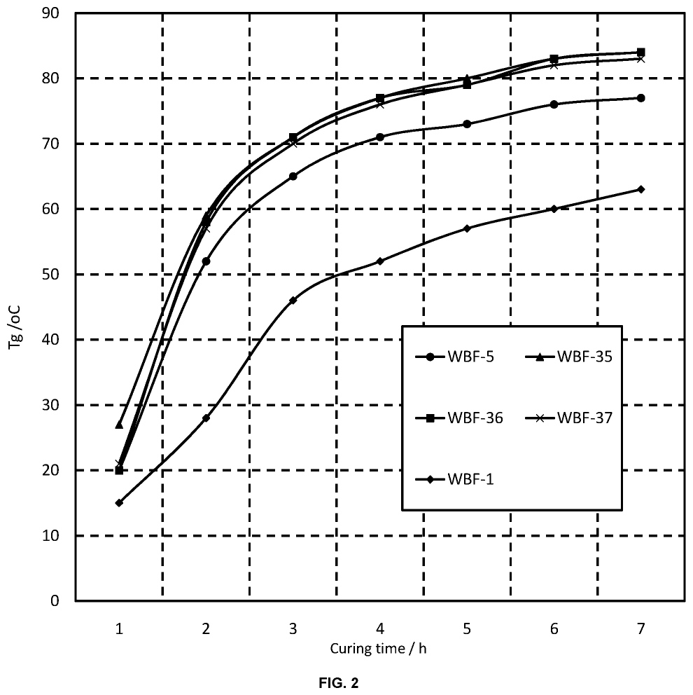

### DETAILED DESCRIPTION

The following description is used merely for illustration but is not to restrict the scope of the disclosure.

The amine composition according to the present disclosure can play the role of curing agents (hardeners), when combined with epoxy resins. The amine composition comprises an alkylated diamine, a tertiary amine, cycloaliphatic diamine and a polyoxyalkyleneamine.

### [Alkylated Diamine]

Alkylated diamine in the present disclosure refers to a diamine having at least one amino group with one of its hydrogen atoms substituted by an alkyl group (—R). Therefore, the alkylated diamine has one secondary amino group (—NHR) or two secondary amino groups (—NHR). The alkylated diamines include mono-alkylated diamines and di-alkylated diamines.

In one preferable embodiment of the invention, the alkylated diamine is represented by the structure:

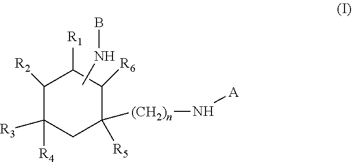

where each of R₁, R₂, R₃, R₄, R₅, and R₆ is H, CH3, or a C2-C4 alkyl group, where n is 0 or 1, where A and B are independently H or a C1-C10 alkyl, and where A and B cannot be H concurrently. The alkylated diamine can preferably come by reaction of the diamine with acetone, methyl ethyl ketone, cyclohexanone, isophorone or aliphatic aldehydes like acetaldehyde, followed by hydrogenation or by reaction of the diamine with an alkyl halide. Therefore, A or B can preferably be a cyclohexyl group, a secondary butyl group, a trimethyl cyclohexyl group, or an isopropyl group derived from the respective ketones, aldehydes, and alkyl halides.

In a preferable embodiment of structure (II), the alkylated diamine is selected from the group consisting of a mono-alkylated isophoronediamine or a di-alkylated isophoronediamine represented by the structure:

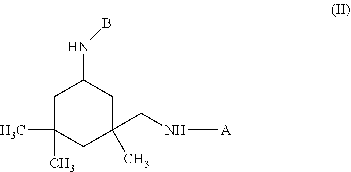

where A and B are independently H or a C1-C10 alkyl, and where A and B cannot be H concurrently; a mono-alkylated methylcyclohexyldiamine or a di-alkylated methylcyclohexyldiamine represented by the structure:

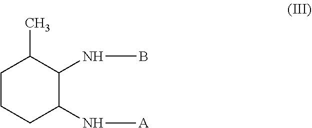

where A and B are independently H or a C1-C10 alkyl, and where A and B cannot be H concurrently; and a mono-alkylated cyclohexyldiamine or a di-alkylated cyclohexyldiamine represented by the structure:

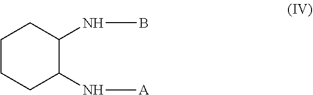

where A and B are independently H or a C1-C10 alkyl, and where A and B cannot be H concurrently.

In another preferred embodiment of the invention, the alkylated diamine is a mono-alkylated diamine or a di-alkylated diamine represented by the structure:

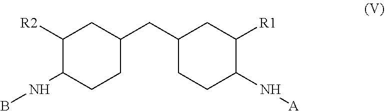

where each of R₁ and R₂ is H or CH3, where A and B are independently H or a C1-C10 alkyl, and where A and B cannot be H concurrently. The alkylated diamine can preferably come by the reaction of the diamine with acetone, methyl ethyl ketone, cyclohexanone, isophorone or aliphatic aldehydes like acetaldehyde, followed by hydrogenation or by reaction of the diamine with an alkyl halide. Therefore, A is preferably a cyclohexyl group, a secondary butyl group, a trimethyl cyclohexyl group, or an isopropyl group derived from the respective ketones, aldehydes, and alkyl halides.

In a further preferred embodiment of structure (VI), the alkylated diamine is selected from the group consisting of a mono-alkylated 4,4′-methylenebis(cyclohexylamine) or a di-alkylated 4,4′-methylenebis(cyclohexylamine) represented by the structure:

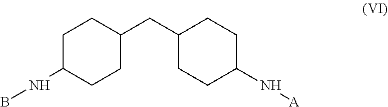

where A and B are independently H or a C1-C10 alkyl, and where A and B cannot be H concurrently; and

a mono-alkylated 2,2′-dimethyl-4,4′-methylenebis(cyclohexylamine) or a di-alkylated 2,2′-dimethyl-4,4′-methylenebis(cyclohexylamine) represented by the structure:

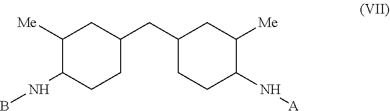

where A and B are independently H or a C1-C10 alkyl, and where A and B cannot be H concurrently.

In another preferred embodiment of the invention, the alkylated diamine is represented by the structure:

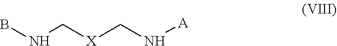

where X is a phenyl or cyclohexyl group, and where A and B are independently H or a C1-C10 alkyl, and where A and B cannot be H concurrently. The alkylated diamine can preferably come by the reaction of the diamine with acetone, methyl ethyl ketone, cyclohexanone, isophorone or aliphatic aldehydes like acetaldehyde, followed by hydrogenation or by reaction of the diamine with an alkyl halide. Therefore, A or B can preferably be a cyclohexyl group, a secondary butyl group, a trimethyl cyclohexyl group, or an isopropyl group derived from the respective ketones, aldehydes, and alkyl halides.

In one preferable embodiment of structure (IX), the alkylated diamine is selected from the group consisting of a mono-alkylated m-xylylenediamine or a di-alkylated m-xylylenediamine represented by the structure:

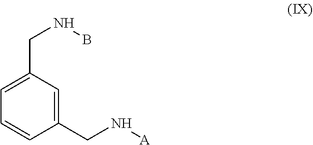

where A and B are independently H or a C1-C10 alkyl, and where A and B cannot be H concurrently; and a mono-alkylated 1,3-bis aminomethylcyclohexane or a di-alkylated 1,3-bis aminomethylcyclohexane represented by the structure:

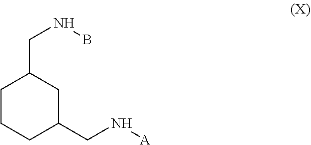

where A and B are independently H or a C1-C10 alkyl, and where A and B cannot be H concurrently.

The alkylated diamine can preferably come by reaction of the corresponding diamine with acetone, methyl ethyl ketone, cyclohexanone, isophorone or aliphatic aldehydes like acetaldehyde, followed by hydrogenation or by reaction of the diamine with an alkyl halide. Therefore, the alkyl group can preferably be a cyclohexyl group, a secondary butyl group, a trimethyl cyclohexyl group, or an isopropyl group derived from the respective ketones, aldehydes, and alkyl halides.

### [Tertiary Amines]

While not bound to any theory, it is thought that the tertiary amine in the amine composition plays a role of a base and/or an accelerator of curing reaction of epoxy resins. By incorporating a tertiary amine into the amine composition, development of the glass transition temperature (T_{g}) of the epoxy system is expedited.

Preferably the tertiary amine includes a phenolic tertiary amine. The phenolic tertiary amine is an aromatic tertiary amine with a hydroxyl group directly connected with the aromatic ring. More preferably, the tertiary amine includes tris-2,4,6-dimethylaminomethyl phenol, isomers of dimethylaminophenols, or isomers of diethylaminophenols.

### [Polyoxyalkyleneamine]

Polyoxyalkyleneamine, sometimes termed “polyetheramine” or “poly(alkyleneoxy) amine”, is a group of organic amines with one or more amino groups attached to polyether backbone. Amino groups include primary amino group (—NH₂), secondary amino groups (—NHR, wherein R is an organic radical other than H atom), and tertiary amino groups (—NR₁R₂, wherein R₁ and R₂ are independently organic radicals other than H atom).

The polyether backbone in polyoxyalkyleneamines used herein contains at least two oxyalkylene moieties (OCₙH₂ₙ, n being an integer of 2 to 10). In some preferable embodiments, the number of oxyalkylene moiety is larger than 2, for example, 3, 4, or 5. The oxyalkylene moiety may preferably be selected from oxyethylene (—OCH₂CH₂—), oxypropylene (—OCH(CH₃)CH₂—, or —OCH₂CH₂CH₂—), oxybutylene (—OCH(CH₃)CH(CH₃)—, —OCH(CH₂CH₃)CH₂—, and —OC(CH₃)₂CH₂—), or any other similar group having the chemical formula (OCₙH₂ₙ, n being an integer of 2 to 10). The oxyalkylene moieties may preferably be identical or different, for example, a mixture of oxyethylene and oxypropylene.

The polyoxyalkyleneamine used in the present disclosure has at least two primary amino groups, for example, Jeffamine® D series polyetheramines. In some preferable embodiments, the polyoxyalkyleneamine has three or more primary amino groups, for instance, Jeffamine® T series polyetheramines may be used.

In some preferable embodiments, the polyoxyalkyleneamine includes a polyoxyethyleneamine, having the following formula:

H₂NCH₂CH₂[OCH₂CH₂]ₓNH₂

wherein x is an integer ranging from 2 to 70. Specific examples are Jeffamine® EDR series diamines from Huntsman Corporation.

In some preferable embodiments, the polyoxyalkyleneamine includes a polyoxypropyleneamine, having the following formula:

H₂NCH(CH₃)CH₂[OCH₂CH(CH₃)]ₓNH₂

wherein x is an integer ranging from 2 to 70. Specific examples are Jeffamine® D series diamines from Huntsman Corporation.

In some preferable embodiments, the polyoxyalkyleneamine includes a polyoxybutyleneamine, having the following formula:

H₂NCH(CH₂CH₃)CH₂[OCH₂CH(CH₂CH₃)]ₓNH₂

wherein x is an integer ranging from 2 to 70.

In some preferable embodiments, the polyoxyalkyleneamine includes a polyoxybutyleneamine, having the following formula:

H₂NCH(CH₃)CH(CH₃)[OCH(CH₃)CH(CH₃)]ₓNH₂

wherein x is an integer ranging from 2 to 70.

In some preferable embodiments, the polyoxyalkyleneamine includes a poly(oxypropylene-co-oxyethylene) amine, having the following formula:

H₂NCH₂CH₂[OCH₂CH₂]ₓ[OCH₂CH(CH₃)]_{y}NH₂

wherein x and y are integers independently ranging from 2 to 70.

In some preferable embodiments, the polyoxyalkyleneamine includes a poly(oxypropylene-co-oxyethylene) amine, having the following formula:

H₂NCH₂CH₂[OCH₂CH₂]ₓ[OCH₂CH(CH₃)]_{y}[OCH₂CH₂]_{z}NH₂

wherein x, y and z are integers independently ranging from 2 to 70.

In some preferable embodiments, the polyoxyalkyleneamine includes a poly(oxypropylene-co-oxyethylene) amine, having the following formula:

H₂NCH(CH₃)CH₂[OCH₂CH(CH₃)]ₓ[OCH₂CH₂]_{y}[OCH₂CH₂]_{z}NH₂

wherein x, y and z are integers independently ranging from 2 to 70. Specific examples are Jeffamine® HK511 diamine (prepared by aminating a diethylene glycol grafted with propylene oxide, with an average molar mass of 220.) or Jeffamine® ED series diamines from Huntsman Corporation.

In some preferable embodiments, the polyoxyalkyleneamine is based on a poly(tetramethylene ether) glycol and polypropylene glycol copolymer, for example, having the following formula:

H₂NCH(CH₃)CH₂[O(CH₂)₄]ₓOCH(CH₃)CH₂NH₂

wherein x is an integer ranging from 1 to 70. Specific examples are Jeffamine® THE series diamines from Huntsman Corporation.

In some preferable embodiments, the polyoxyalkyleneamine includes a poly(oxypropylene-co-oxyethylene) amine, having the following formula:

H₂N(CH₂)₃[OCH₂CH₂]ₓO(CH₂)₃NH₂

wherein x is an integer ranging from 1 to 70. Specific examples are 1,13-diamino-4,7,10-trioxatridecane (Ancamine® 1922A from Evonik Resource Efficiency GmbH) or 4,7-dioxadecane-1,10-diamine.

In some preferable embodiments, the polyoxyalkyleneamine includes a polyoxypropyleneamine, having the following formula:

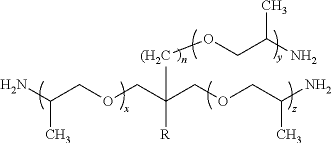

wherein, R is a radical selected from H, CH₃, CH₂CH₃, CH₂CH₂CH₃, or CH(CH₃)₂; n is 0 or 1; x, y, and z are integers independently ranging from 1 to 30; and the sum of x, y, and z is ranging from 3 to 90. Specific examples are Jeffamine® T series triamines from Huntsman Corporation.

It will be appreciated that polyoxyalkyleneamines used in the present disclosure may be a mixture of polymers or oligomers having varying degrees of polymerization. For example, when polyoxypropyleneamine is used, the repeating number x as in

H₂NCH(CH₃)CH₂[OCH₂CH(CH₃)]ₓNH₂

may be within a distribution, for example, a distribution ranging from 2 to 30, rather than a specific integer.

In some preferable embodiments, a diamine, triamine, or tetraamine that has a primary amino-terminated polyoxyalkylene backbone may be employed. Specific examples include Jeffamine® RFD270 amine from Huntsman Corporation, which contains both rigid cycloaliphatic and flexible polyetheramine segments in the same molecule. Other reference may be made to Jeffamine® XTJ616 from Huntsman Corporation, which comprises a polyetheramine based on pentaerythritol and propylene oxide with an average molecular weight of about 660.

The above mentioned polyoxyalkyleneamines are commercially available from various chemical manufacturers. For example, Jeffamine® D230, Jeffamine® D400, Jeffamine® D2000, Jeffamine® D4000, Jeffamine® ED600, Jeffamine® ED900, Jeffamine® ED2003, Jeffamine® EDR104, Jeffamine® EDR148, Jeffamine® EDR176, Jeffamine® EDR192, Jeffamine® THF100, Jeffamine® THF140, Jeffamine® THF170, Jeffamine® T403, Jeffamine® T3000, Jeffamine® T5000, Jeffamine® RFD270, Jeffamine® XTJ616 from Huntsman Corporation; Baxxodur® EC 301, Baxxodur® EC 310, Baxxodur® EC 302, Baxxodur® EC 303, Baxxodur® EC 311 from BASF SE; or Ancamine® 1922A from Evonik Resource Efficiency GmbH.

### [Cycloaliphatic Amines]

The amine composition according to the present disclosure may further include a cycloaliphatic amine serving as a co-curing agent of epoxy resins. Preferably the cycloaliphatic amine includes one or more selected from the group consisting of isophorone diamine, methylcyclohexyldiamine, cyclohexyldiamine, 4,4′-methylenebis(cyclohexylamine), isomers of xylylenediamines, 1,2-bis aminomethylcyclohexane, 1,3-bis aminomethylcyclohexane, or 1,4-bis aminomethylcyclohexane.

Preferably, the amine composition according to the disclosure consists of the above specified components.

### [Epoxy Resins]

The amine composition of the present disclosure can be used with epoxy resins already known in the art, to form a two-composition epoxy system. In the present disclosure, the epoxy resin can preferably include one or more glycidyl ethers selected from the group of glycidyl ethers of: resorcinol, hydroquinone, 4,4′-methylenebis(2,6-dimethylphenol) (tetramethyl bisphenol F), bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane (bisphenol A), bis-(4-hydroxyphenyl)-methane (bisphenol F), and any combination thereof. The epoxy resins are commercially available from various chemical manufacturers, for example, D.E.R.™ 331, 351, or 731 from DOW Chemical Company. Several epoxy compounds are also described, for example, in EP 675 185 A1.

Useful compounds are a multitude of those known for this purpose that contain more than one epoxy group, preferably two epoxy groups, per molecule. These epoxy compounds can preferably either be saturated or unsaturated. They are preferably aliphatic, cycloaliphatic, aromatic, or heterocyclic, and have hydroxyl groups. They preferably contain such substituents that do not cause any side reactions under the mixing or reaction conditions, for example alkyl or aryl substituents, ether moieties and the like. They are preferably glycidyl ethers which derive from polyhydric phenols, especially bisphenols and novolac, and which have molar masses based on the number of epoxy groups ME (“epoxy equivalent weights”, “EV value”) between 100 and 1500 g/eq, but especially between 150 and 250 g/eq.

Examples of polyhydric phenols include: resorcinol, hydroquinone, 2,2-bis(4-hydroxyphenyl)propane (bisphenol A), isomer mixtures of dihydroxydiphenylmethane (bisphenol F), 4,4′-dihydroxydiphenylcyclohexane, 4,4′-dihydroxy-3,3′-dimethyldiphenylpropane, 4,4′-dihydroxydiphenyl, 4,4′-dihydroxybenzophenone, bis(4-hydroxyphenyl)-1,1-ethane, bis(4-hydroxyphenyl)-1,1-isobutane, 2,2-bis(4-hydroxy-tert-butylphenyl)propane, bis(2-hydroxynaphthyl)methane, 1,5-dihydroxynaphthalene, tris(4-hydroxyphenyl)methane, bis(4-hydroxyphenyl) ether, bis(4-hydroxyphenyl) sulphone inter alia, and the chlorination and bromination products of the aforementioned compounds, for example tetrabromobisphenol A. Very particular preference is given to using liquid diglycidyl ethers based on bisphenol A and bisphenol F having an epoxy equivalent weight of 150 to 200 g/eq. It is also possible to use polyglycidyl ethers of polyols, for example ethane-1,2-diol diglycidyl ether, propane-1,2-diol diglycidyl ether, propane-1,3-diol diglycidyl ether, butanediol diglycidyl ether, pentanediol diglycidyl ether (including neopentyl glycol diglycidyl ether), hexanediol diglycidyl ether, diethylene glycol diglycidyl ether, dipropylene glycol diglycidyl ether, higher polyoxyalkylene glycol diglycidyl ethers, for example higher polyoxyethylene glycol diglycidyl ethers and polyoxypropylene glycol diglycidyl ethers, co-polyoxyethylene-propylene glycol diglycidyl ethers, polyoxytetramethylene glycol diglycidyl ethers, polyglycidyl ethers of glycerol, of hexane-1,2,6-triol, of trimethylolpropane, of trimethylolethane, of pentaerythritol or of sorbitol, polyglycidyl ethers of oxyalkylated polyols (for example of glycerol, trimethylolpropane, pentaerythritol, inter alia), diglycidyl ethers of cyclohexanedimethanol, of bis(4-hydroxycyclohexyl)methane and of 2,2-bis(4-hydroxycyclohexyl)propane, polyglycidyl ethers of castor oil, triglycidyl tris(2-hydroxyethyl)isocyanurate.

Further useful component A) includes poly(N-glycidyl) compounds obtainable by dehydrohalogenation of the reaction products of epichlorohydrin and amines such as aniline, n-butylamine, bis(4-aminophenyl)methane, m-xylylenediamine or bis(4-methylaminophenyl)methane. The poly(N-glycidyl) compounds also include triglycidyl isocyanurate, triglycidylurazole and oligomers thereof, N,N′-diglycidyl derivatives of cycloalkyleneureas and diglycidyl derivatives of hydantoins inter alia.

In addition, it is also possible to use polyglycidyl esters of polycarboxylic acids which are obtained by the reaction of epichlorohydrin or similar epoxy compounds with an aliphatic, cycloaliphatic or aromatic polycarboxylic acid such as oxalic acid, succinic acid, adipic acid, glutaric acid, phthalic acid, terephthalic acid, tetrahydrophthalic acid, hexahydrophthalic acid, naphthalene-2,6-dicarboxylic acid and higher diglycidyl dicarboxylates, for example dimerized or trimerized linolenic acid. Examples are diglycidyl adipate, diglycidyl phthalate and diglycidyl hexahydrophthalate.

Mention should additionally be made of glycidyl esters of unsaturated carboxylic acids and epoxidized esters of unsaturated alcohols or unsaturated carboxylic acids. In addition to the polyglycidyl ethers, it is possible to use small amounts of monoepoxides, for example methyl glycidyl ether, butyl glycidyl ether, allyl glycidyl ether, ethylhexyl glycidyl ether, long-chain aliphatic glycidyl ethers, for example cetyl glycidyl ether and stearyl glycidyl ether, monoglycidyl ethers of a higher isomeric alcohol mixture, glycidyl ethers of a mixture of C12 to C13 alcohols, glycidyl ethers of a mixture of C12 to C14 alcohols, phenyl glycidyl ether, cresyl glycidyl ether, p-tert-butylphenyl glycidyl ether, p-octylphenyl glycidyl ether, p-phenylphenyl glycidyl ether, glycidyl ethers of an alkoxylated lauryl alcohol, and also monoepoxides such as epoxidized monounsaturated hydrocarbons (butylene oxide, cyclohexene oxide, styrene oxide), in proportions by mass of up to 30% by weight, preferably 10% to 20% by weight, based on the mass of the polyglycidyl ethers. It is also possible to use polyglycidyl ethers of polyols, for example ethane-1,2-diol diglycidyl ether, propane-1,2-diol diglycidyl ether, propane-1,3-diol diglycidyl ether, butanediol diglycidyl ether, pentanediol diglycidyl ether (including neopentyl glycol diglycidyl ether), hexanediol diglycidyl ether, diethylene glycol diglycidyl ether, dipropylene glycol diglycidyl ether, higher polyoxyalkylene glycol diglycidyl ethers, for example higher polyoxyethylene glycol diglycidyl ethers and polyoxypropylene glycol diglycidyl ethers, co-polyoxyethylene-propylene glycol diglycidyl ethers, polyoxytetramethylene glycol diglycidyl ethers, polyglycidyl ethers of glycerol, of hexane-1,2,6-triol, of trimethylolpropane, of trimethylolethane, of pentaerythritol or of sorbitol, polyglycidyl ethers of oxyalkylated polyols (for example of glycerol, trimethylolpropane, pentaerythritol, inter alia), diglycidyl ethers of cyclohexanedimethanol, of bis(4-hydroxycyclohexyl)methane and of 2,2-bis(4-hydroxycyclohexyl)propane, polyglycidyl ethers of castor oil, triglycidyl tris(2-hydroxyethyl)isocyanurate.

Useful epoxy compounds preferably include glycidyl ethers and glycidyl esters, aliphatic epoxides, diglycidyl ethers based on bisphenol A and/or bisphenol F, and glycidyl methacrylates. Other examples of such epoxides are triglycidyl isocyanurate (TGIC, trade name: ARALDIT 810, Huntsman), mixtures of diglycidyl terephthalate and triglycidyl trimellitate (trade name: ARALDIT PT 910 and 912, Huntsman), glycidyl esters of versatic acid (trade name: CARDURA E10, Shell), 3,4-epoxycyclohexylmethyl 3,4′-epoxycyclohexanecarboxylate (ECC), ethylhexyl glycidyl ether, butyl glycidyl ether, pentaerythrityl tetraglycidyl ether (trade name: POLYPDX R 16, UPPC AG), and other Polypox products having free epoxy groups. It is also possible to use mixtures of the epoxy compounds mentioned.

Particularly preferred epoxy components are polyepoxides based on bisphenol A diglycidyl ether, bisphenol F diglycidyl ether, 4,4′-methylenebis[N,N-bis(2,3-epoxypropyl)aniline], hexanediol diglycidyl ether, butanediol diglycidyl ether, trimethylolpropane triglycidyl ether, propane-1,2,3-triol triglycidyl ether, pentaerythritol tetraglycidyl ether and diglycidyl hexahydrophthalate.

According to the present disclosure, it is also possible with preference to use mixtures of these epoxy compounds in the epoxy resin.

The epoxy resin may be in various forms, such as, a crystalline form, a powdered form, a semi-solid form, a liquid form, etc. For the liquid form, the epoxy resin may be dissolved in a solvent, for example, water or a reactive diluent. Preferably, the epoxy resin is in a liquid form, to facilitate the mixing process. The reactive diluent may be a mono-epoxide diluent or a multi-epoxide diluent.

### [Epoxy System]

An epoxy resin system can preferably be produced by a method known by a skilled person, wherein an amine composition according to the present disclosure is combined with an epoxy resin.

The epoxy resin includes one or more glycidyl ethers selected from the group of glycidyl ethers of: resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane, bis-(4-hydroxyphenyl)-methane, and any combination thereof.

The epoxy system may include further a reactive diluent. Reactive diluents are compounds that participate in a curing reaction of epoxy resins with the amine component and become incorporated into the cured composition. Reactive diluents are preferably monofunctional epoxides and multifunctional epoxides. Reactive diluents may also be used to vary the viscosity and/or cure properties of the curable compositions for various applications. For some applications, reactive diluents may impart a lower viscosity to influence flow properties, extend pot life and/or improve adhesion properties of the curable compositions. For example, the viscosity may be reduced to allow an increase in the level of pigment in a formulation or composition while still permitting easy application, or to allow the use of a higher molecular weight epoxy resin. Thus, it is within the scope of the present disclosure for the epoxy component, which comprises at least one multifunctional epoxy resin, to further comprise a monofunctional or multifunctional epoxide. Examples of monofunctional epoxides include, but are not limited to, styrene oxide, cyclohexene oxide and the glycidyl ethers of phenol, cresols, tert-butylphenol, other alkyl phenols, butanol, 2-ethylhexanol, C4 to C14 alcohols, and the like, or combinations thereof. Examples of multifunctional epoxides include, but are not limited to butanediol diglycidyl ether, pentanediol diglycidyl ether (including neopentyl glycol diglycidyl ether), hexanediol diglycidyl ether, dipropylene glycol diglycidyl ether, diglycidyl ethers of cyclohexanedimethanol, of bis(4-hydroxycyclohexyl)methane and of2,2-bis(4-hydroxycyclohexyl)propane, or combinations thereof.

The multifunctional epoxy resin may also be present in a solution or emulsion, with the diluent being water, an organic solvent, or a mixture thereof. The amount of multifunctional epoxy resin may range from 50% to 100%, 50% to 90%, 60% to 90%, 70% to 90%, and in some cases 80% to 90%, by weight, of the epoxy component. For one or more of the embodiments, the reactive diluent is less than 60 weight percent of a total weight of the resin component.

Within the epoxy system, the amine composition has a weight percentage of 10% to 40%, and the epoxy resin has a weight percentage of 60% to 90%, based on a total weight of the epoxy system.

The epoxy system is a curable system which, when cured, could find various applications. The curable epoxy system and cured products described herein may be useful as structural and electrical laminates, coatings, castings, structural components (particularly for aerospace industries), and as circuit boards and the like for the electronics industry, among other applications. The curable epoxy system disclosed herein may also be used in electrical varnishes, encapsulants, semiconductors, general molding powders, filament wound pipes and fittings, filament wound pressure vessels, low and high pressure pipes and fittings, low and high pressure vessels, storage tanks, wind turbine blades, automotive structural parts, aerospace structural parts, oil and gas buoyance modules, rigs, well plugs, cure-in-place-pipe (CIPP), structural bonding adhesives and laminates, a composite liner, liners for pumps, corrosion resistant coatings, and other suitable epoxy containing products.

The curable epoxy system may be used to form composite materials based on reinforced fiber substrates. The reinforced fiber substrate may preferably be one or more layers of fiberglass material. Contacting the reinforcing fiber substrate with the epoxy resin system may preferably comprise an application process selected from the group consisting of hand lamination, an infusion process, filament winding, pultrusion, resin transfer molding, fiber pre-impregnation processes, and combinations thereof.

Preferable fiber substrates include organic or inorganic fibers, natural fibers or synthetic fibers, and may be present in the form of wovens or non-crimp fabrics, nonwovens webs or mats, and also in the form of fiber stands (rovings), or staple fiber formed of continuous or discontinuous fiber such as fiber glass, carbon fiber, carbon nanotubes, nano composite fibers, polyaramide fibers such as those sold under the trade name KEVLAR®, Poly(p-phenylene benzobisoxazole) fiber such as those sold under the trade name ZYLON®, ultrahigh molecular weight polyethylene fibers such as those sold under the trade name SPECTRA®, high and low density polyethylene fibers, polypropylene fibers, nylon fibers, cellulose fibers, natural fibers, biodegradable fibers and combinations thereof.

Preferably, these fibers (woven or non-woven) can be coated with the solvent or solvent free epoxy resin mixture by the standard impregnating methods, in particular for filament winding (FW), pultrusion, sheet molding compound, bulk molding compound autoclave molding, resin infusion, vacuum assisted resin transfer molding (VAR™), resin transfer molding (RTM), wet/hand lay-up, vacuum bagging, resin impregnation, prepreg, fiber impregnation, compression molding (CM), brushing, spraying, or dipping, casting, injection molding or combination thereof.

Based on the epoxy system, compositions can be developed. The compositions comprise the epoxy system according to the present disclosure and optionally auxiliaries or additives.

The compositions can preferably be applied in various sectors, including electrical equipment, sports items, optical equipment, sanitary and hygiene items, household equipment, communications technology, automobile technology, energy and drive technology, mechanical engineering, and medical equipment.

Specifically, a turbine blade including the composition of the present disclosure can preferably be used in wind energy. More specifically, the epoxy system or the compositions could be used to produce wind turbine blades.

### [Additives]

To bring in more functionality or features to satisfy industrial requirements, the epoxy system can preferably include additives. Additives are understood to mean substances which are added to alter the properties of the epoxy system in the desired direction, for example to match viscosity, wetting characteristics, stability, reaction rate, blister formation, storability or adhesion, and use properties, to the end application. Several additives are described, for example, in WO 99/55772, pp. 15-25.

Preferred additives can be selected from the group consisting of fillers, reinforcing agents, coupling agents, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, adhesion promoters, anti-dripping agents, metallic pigments, stabilizers, metal glitters, metal coated particles, porosity inducers, plasticizers, glass fibers, nanoparticles, flow assistants, and combinations thereof.

The additive preferably constitutes a proportion of not greater than 90 wt. %, preferably not greater than 70 wt. %, more preferably not greater than 50 wt. %, still more preferably not greater than 30 wt. %, with respect to the total weight of composition.

For example, it can be advantageous to add light stabilizers, for example sterically hindered amines, or other auxiliaries as described, for example, in EP 669 353 in a total amount of 0.05% to 5% by weight.

To produce the epoxy system of the present disclosure, it is additionally possible to add additives such as levelling agents, for example polysilicones, or adhesion promoters, for example those based on acrylate. In addition, still further components may optionally be present. Auxiliaries and additives used in addition may be chain transfer agents, plasticizers, stabilizers and/or inhibitors.

In some cases, the epoxy system can preferably include an antioxidant additive. The antioxidant might include one or more of the structural units selected from sterically hindered phenols, sulfides, or benzoates. Here, in sterically hindered phenols, the two orthohydrogens are substituted by compounds which are not hydrogen and preferably carry at least 1 to 20, particularly preferably 3 to 15, carbon atoms and are preferably branched. Benzoates also carry, preferably in the ortho position relative to the OH group, substituents which are not hydrogen and carry particularly preferably 1 to 20, more preferably, 3 to 15, carbon atoms, which are preferably branched.

The disclosure is illustrated by way of example and comparative examples hereinbelow.

### Examples

The following materials were employed in the examples.

D.E.R.™ 331 liquid epoxy resin from the Dow Chemical Company is a liquid reaction product of epichlorohydrin and bisphenol A.

NPEL-127 liquid epoxy resin from Nanya Plastics Corporation is a diglycidyl ether of bisphenol A.

Epodil®748 epoxy reactive diluent from Evonik Specialty Chemicals (Shanghai) Co., Ltd. is a glycidyl ether of C12-C14 aliphatic alcohols.

Epodil®750 epoxy reactive diluent from Evonik Specialty Chemicals (Shanghai) Co., Ltd. is a glycidyl ether of 1,4-butanediol.

N-sec-butyl isophoronediamine with minor amount of N,N′-sec-butyl isophoronediamine and isophoronediamine (hereinafter “alkylated amine 1”) was prepared according to the method described in EP3680270A1.

Vestamin IPD from Evonik Specialty Chemicals (Shanghai) Co., Ltd. is isophorone diamine.

Vestamin PACM from Evonik Specialty Chemicals (Shanghai) Co., Ltd. is bis(aminocyclohexyl)methane (PACM).

Ancamine® 2049 from Evonik Specialty Chemicals (Shanghai) Co., Ltd. is 3,3′-dimethyl-4,4′ diaminodicyclohexylmethane (DMDC).

Baxxodur® EC210 from BASF SE is methyl-diaminocyclohexane (HTDA).

Ancamine® K54 from Evonik Specialty Chemicals (Shanghai) Co., Ltd. is tris(dimethylaminomethyl)phenol.

Ancamine® K61B from Evonik Specialty Chemicals (Shanghai) Co., Ltd. is tris (dimethylaminomethyl)phenol tri (2-ethyl hexoate).

A mixture of aliphatic and cyclic amines with secondary and tertiary amine (hereinafter “Cyclic DETA”) was prepared from formaldehyde and diethylene triamine according to EP3170849B1. Cyclic DETA contains mainly 1-(2-aminoethyl)imidazolidine and other heterocyclic amines.

Jeffamine® D230 from Huntsman Corporation is a polyoxypropylenediamine.

Viscosity was measured by a Brookfield DV-II+Pro Viscometer at 25° C. Glass transition temperature was tested using DSC according to ASTM D3418-82 with a heating rate of 10° C./min from 0 to 250° C. The midpoint of the steep portion of cure curve was taken as T_{g}. The DSC instrument utilized was a TA Instruments DSC Model Q2000. T_{g} wet was determined on the second scan curve for wet mixtures.

For T_{g} development rate, the mixture was prepared according to the respective formulations. 5 to 10 mg of the mixture were placed into several sealed aluminum sample pans and then cured in an oven at 70° C. A DSC pan of each formulation was taken from the oven at one-hour intervals from 1-7 hours during the curing process. At the end of each curing period, T_{g} of the samples in DSC pans was determined by 2 scans in DSC. T_{g} 1 was measured in first scan. T_{g} 2 was measured in second scan. Peak temperature and exothermic peak duration of 150 g mixture at pre-determined temperature was tested by temperature recorder 2103R from Shanghai Yadu Electronic Technology Co., Ltd. 150 g of epoxy mixtures were prepared in a 250 mL polypropylene beaker. A thermocouple was placed into the beaker and positioned at the center of the liquid mixture. The beaker was placed into a temperature control climatic chamber. The temperature at the center of the mixture was monitored as a function of time. Maximum temperature and the times to reach such temperatures were recorded.

Gel time was measured by a Techne Gelation Timer for 150 g mixture at pre-determined temperature. 25 g of wet mixture after mixing by a Speedmixer for 2 minutes was put in a Brookfield Viscometer tube at pre-determined temperature conditioned by water bath. The pot life of wet mixture was determined as the time during which the viscosity reached to 1,000 mP-s or the final value of the viscosity doubled, compared with the initial value.

Tensile properties including tensile strength, elongation and tensile modulus were tested according to GB/T 2567-2008.

Flexural properties including flexural strength and flexural modulus were tested according to GB/T 2567-2008.

Compressive strength was tested according to GB/T 2567-2008.

### Examples

WBF-5 is standard formula for long pot life wind blade composites. Here, WBF-5 served as a control example as it did not contain an alkylated diamine. WBF-25 served as another control example as it did not contain a tertiary amine.

For windmill blade fabrication, it was desired that the curing time at 70° C. needs to achieve a T_{g} of 70° C. within 3 hours or less. Existing compositions required a duration greater than 3 hours as shown below in WBF-5. A fast development of a T_{g} of at least 70° C. is important for demolding.

From testing data of WBF-35, it could be observed that the formulation achieved a long pot life and fast development of T_{g} at the same time, which is desired in the wind power manufacture. The epoxy systems in WBF-35, 36, and 37 further show low exotherm, low viscosity, high T_{g}, as well as good mechanical properties.

Surprisingly it was found that a combination of alkylated diamine, cycloaliphatic diamine, polyoxyalkyleneamine, and tertiary amine such as tris (dimethylaminomethyl)phenol could realize a fast development of T_{g} and a T_{g} 1 of 72° C. after 3 hours at 70° C. as shown by WBF-21. After addition of cycloaliphatic amines and polyoxyalkyleneamines, the epoxy system could achieve a T_{g} 2 of greater than 80° C., while maintaining a long pot life. WBF-36 and WBF-37 had significantly low exotherm and longer pot life than WBF-35 due to off-stoichiometric ratio, which didn't affect mechanical properties.

TABLE 1

| Examples | BA-1 | BA-2 | BA-3 | BA-4 | BA-5 |
|---|---|---|---|---|---|
| DER 331, g | 100 | 100 | 100 | 100 | 100 |
| Alkylated amine 1, g | 36.8 | — | — | — | — |
| Vestamin PACM, g | — | 27.6 | — | — | — |
| Ancamine 2049, g | — | — | 31.6 | — | — |
| Baxxodur EC210, g | — | — | — | 17.4 | — |
| Vestamin IPDA, g | — | — | — | — | 22.4 |

DSC analysis

| | | | | | |
|---|---|---|---|---|---|
| DSC 1st scan onset temp., ° C. | 90 | 85 | 96 | 86 | 82 |
| DSC 1st scan peak temp., ° C. | 132 | 118 | 131 | 120 | 116 |
| T_{g} wet, ° C. | 116 | 156 | 134 | 160 | 155 |

Processing properties

| | | | | | |
|---|---|---|---|---|---|
| Initial mixing viscosity at 25° C., mPa · s | 1,188 | 2,971 | 2,578 | 1,537 | 2,161 |
| Initial mixing viscosity at 40° C., mPa · s | 318 | 1,450 | 864 | 489 | 690 |
| Time to double viscosity at 25° C., min | 139 | 57 | 86 | 79 | 50 |
| Time to 10,000 mPa · s at 25° C., min | 306 | 88 | 156 | 165 | 97 |
| Time to double viscosity at 40° C., min | 64 | 28 | 57 | 39 | 28 |
| Time to 10,000 mPa · s at 40° C., min | 189 | 52 | 126 | 93 | 62 |
| Gel time (150 g at 25° C.), min | 442 | 144 | 302 | 151 | 103 |
| Max. temp. (150 g at 25° C.), ° C. | 34 | 144 | 50 | 140 | 139 |
| Time to max. temp. (150 g at 25° C.), min | 308 | 130 | 350 | 172 | 116 |

Tensile properties (curing condition: 90° C./1 h + 150° C./3 h)

| | | | | | |
|---|---|---|---|---|---|
| Tensile strength, MPa | 54 | 58.5 | 55 | 45 | 76 |
| Tensile modulus, MPa | 2,400 | 2,100 | 2,100 | 2,500 | 2,700 |
| Tensile elongation, % | 2.8 | 4.5 | 3.9 | 2.3 | 3.0 |

TABLE 2

| | | | | | |
|---|---|---|---|---|---|
| Examples | WBF-1 | WBF-2 | WBF-3 | WBF-4 | WBF-5 |

Resin formulation:

| | | | | | |
|---|---|---|---|---|---|
| NPEL-127, g | 86 | 86 | 86 | 86 | 86 |
| Epodil 750, g | 14 | 14 | 14 | 14 | 14 |

Hardener formulation:

| | | | | | |
|---|---|---|---|---|---|
| Alkylated amine 1, g | 30 | — | — | — | — |
| Vestamin PACM, g | — | 30 | — | — | — |
| Ancamine 2049, g | — | — | 30 | — | — |
| Baxxodur EC 210, g | — | — | — | 30 | — |
| Vestamin IPDA, g | — | — | — | — | 30 |
| Jeffamine D230, g | 70 | 70 | 70 | 70 | 70 |
| Hardener PHR | 36.3 | 33.3 | 34.7 | 27.9 | 30.9 |

DSC Analysis

| | | | | | |
|---|---|---|---|---|---|
| DSC 1st scan onset temp., ° C. | 93 | 90 | 95 | 92 | 88 |
| DSC 1st scan peak temp., ° C. | 402 | 460 | 432 | 465 | 427 |
| Tg wet, ° C. | 76 | 86 | 81 | 91 | 89 |

Processing properties

| | | | | | |
|---|---|---|---|---|---|
| Gel time (150 g at 25° C.), minutes | 885 | 481 | 596 | 473 | 454 |
| Gel time (150 g at 40° C.), minutes | 137 | 88 | 113 | 98 | 81 |
| Initial mixing viscosity at 25° C., mPa · s | 298 | 355 | 427 | 343 | 386 |
| Max. exothermic temp. (150 g at 25° C.), ° C. | 35 | 58 | 40 | 93 | 102 |
| Time to max. temp. (150 g at 25° C.), min | 472 | 396 | 484 | 334 | 290 |
| Time to 1,000 mPa · s at 25° C., min | 402 | 176 | 232 | 208 | 154 |
| Initial mixing viscosity at 40° C., mPa · s | 110 | 137 | 128 | 122 | 114 |
| Time to 1,000 mPa · s at 40° C., min | 169 | 114 | 151 | 122 | 110 |
| Max. exothermic temp (150 g at 40° C.), ° C. | 138 | 167 | 144 | 175 | 152 |
| Time to max. temp (150 g at 40° C.), min | 150 | 110 | 142 | 108 | 102 |

Tensile properties (curing condition: 25° C./24 h + 80° C./10 h)

| | | | | | |
|---|---|---|---|---|---|
| Tensile strength, MPa | 58 | 57 | 62 | 65 | 65 |
| Tensile elongation, % | 7.6 | 5.4 | 7.3 | 7.3 | 7.5 |

TABLE 3

| | | | | | | |
|---|---|---|---|---|---|---|
| Examples | WBF-5 | WBF-11 | WBF-21 | WBF-24 | WBF-25 | WBF-35 |

Resin formulation

| | | | | | | |
|---|---|---|---|---|---|---|
| NPEL-127, g | 86 | 86 | 86 | 86 | 86 | 86 |
| Epodil 750, g | 14 | 14 | 14 | 14 | 14 | 14 |

Hardener formulation

| | | | | | | |
|---|---|---|---|---|---|---|
| Alkylated amine 1, g | — | 10 | 10 | 10 | 10 | 10 |
| Vestamin IPDA, g | 30 | 15 | 15 | 15 | 15 | 22 |
| Cyclic DETA, g | — | 5 | — | — | — | — |
| Ancamine K54, g | — | — | 5 | — | — | 3 |
| Ancamine K61B, g | — | — | — | 5 | — | — |
| Jeffamine D230, g | 70 | 70 | 70 | 70 | 70 | 65 |
| Total hardener, g | 100 | 100 | 100 | 100 | 95 | 100 |
| Hardener AHEW, g/eq | 53.5 | 57.6 | 60.2 | 60.2 | 57.2 | 57.4 |
| Hardener PHR | 31.8 | 34.2 | 35.8 | 35.3 | 34.0 | 34.1 |

DSC analysis

| | | | | | | |
|---|---|---|---|---|---|---|
| Onset temp, ° C. | 88 | 86 | 89 | 90 | 91 | 90 |
| Peak temp, ° C. | 127 | 127 | 127 | 128 | 131 | 126 |
| Enthalpy, J/g | 427 | 433 | 427 | 418 | 431 | 432 |
| T_{g} wet, ° C. | 89 | 76 | 74 | 76 | 80 | 84 |
| T_{g} 1 after 3 h at 70° C. | 64 | 59 | 72 | 61 | 53 | 71 |
| T_{g} 2 after 3 h at 70° C. | 88 | 79 | 74 | 75 | 81 | 84 |
| Gel time (150 g at 25° C.), min | 320 | — | 335 | — | 457 | 340 |

TABLE 4

| | | | | |
|---|---|---|---|---|
| Examples | WBF-5 | WBF-35 | WBF-36 | WBF-37 |

Resin formulation

| | | | | |
|---|---|---|---|---|
| NPEL-127, g | 86 | 86 | 86 | 86 |
| Epodil 750, g | 14 | 14 | 14 | 14 |

Hardener formulation

| | | | | |
|---|---|---|---|---|
| Alkylated amine 1, g | — | 10 | 10 | 10 |
| Vestamin IPDA, g | 30 | 22 | 22 | 22 |
| Ancamine K54, g | — | 3 | 3 | 3 |
| Jeffamine D230, g | 70 | 65 | 65 | 65 |
| Total hardener, g | 100 | 100 | 100 | 100 |
| Resin EEW, g/eq | 168.3 | 168.3 | 168.3 | 168.3 |
| Hardener AHEW, g/eq | 53.5 | 57.4 | 57.4 | 57.4 |
| Stoichiometric ratio | 1.0 | 1.0 | 0.95 | 0.9 |
| Hardener PHR | 31.8 | 34.1 | 32.4 | 30.7 |

DSC analysis

| | | | | |
|---|---|---|---|---|
| Tg wet, ° C. | 89 | 84 | 81 | 81 |
| Tg 2 after 3 h at 70° C., ° C. | 88 | 84 | 87 | 85 |

Process properties

| | | | | |
|---|---|---|---|---|
| Initial viscosity at 25° C., mPa · s | 396 | 310 | 342 | 384 |
| Time to 1000 mPa · s at 25° C., min | 123 | 174 | 176 | 180 |
| Gel time (150 g at 25° C.), min | 320 | 340 | 326 | 332 |
| Max. temp (150 g at 25° C.), ° C. | 119 | 133 | 90 | 70 |
| Time to max temp at 25° C., min | 260 | 243 | 240 | 293 |
| Initial viscosity at 35° C., mPa · s | 204 | 201 | 175 | 208 |
| Time to 1000 mPa · s at 35° C., min | 114 | 113 | 122 | 128 |
| Gel time (150 g at 35° C.), min | 176 | 170 | 178 | 185 |
| Max. temp (150 g at 35° C.), ° C. | 156 | 149 | 144 | 140 |
| Time to max temp at 35° C., min | 122 | 126 | 126 | 128 |

Mechanical properties (curing condition: 25° C./24 h + 80° C./10 h)

| | | | | |
|---|---|---|---|---|
| Tensile strength, MPa | 72 | 71 | 73 | 72 |
| Tensile modulus, MPa | 3,100 | 2,995 | 2,920 | 2,950 |
| Tensile elongation, % | 5.2 | 5.1 | 5.4 | 5.6 |
| Flexural strength, MPa | 117 | 106 | 113 | 114 |
| Flexural modulus, MPa | 2,973 | 2,762 | 2,605 | 2,713 |
| Compress strength, MPa | 92 | 89 | 91 | 90 |

From Table 2, it is found that when mixing with commonly used polyoxyalkyleneamine, Alkylated amine 1 could realize a much longer pot life compared to any other amine under 25° C. Thus, the combination of polyoxyalkyleneamine and alkylated amine is essential for achieving a long pot life.

A commercial epoxy system for long pot life wind blade composites was purchased and tested in the same environment as the examples. Although the exact chemical composition was not known, the commercial epoxy system could be considered as a benchmark of performance such as pot life, development of T_{g}, and mechanical properties. The following testing data was obtained.

DSC analysis

| | |
|---|---|
| Tg wet, ° C. | 79 |
| Tg 1 after 3 h at 70° C., ° C. | 56 |
| Tg 2 after 3 h at 70° C., ° C. | 80 |

Process properties

| | |
|---|---|
| Initial viscosity at 25° C., mPa · s | 298 |
| Time to 1000 mPa · s at 25 ° C., min | 222 |
| Gel time (150 g at 25° C.), min | 415 |
| Max. temp (150 g at 2 ° C.), ° C. | 53 |
| Time to max temp at 25° C., min | 314 |

Mechanical properties

| | |
|---|---|
| Tensile strength, MPa | 63 |
| Tensile modulus, MPa | 3,180 |
| Tensile elongation, % | 3.5 |
| Flexural strength, MPa | 116 |
| Flexural modulus, MPa | 3,114 |
| Compress strength, MPa | 85 |

It could be observed that epoxy system with the hardener in WBF-35 could achieve a much longer pot life and a faster development of T_{g} compared to the commercial epoxy system.

Various aspects and embodiments are possible. Some of those aspects and embodiments are described herein. After reading this specification, skilled artisans will appreciate that those aspects and embodiments are only illustrative and do not limit the scope of the present disclosure. Embodiments may be in accordance with any one or more of the embodiments as listed below.

The above description is presented to enable a person skilled in the art to make and use the disclosure and is provided in the context of an application and its requirements. Various modifications to the preferred embodiments will be apparent to those skilled in the art, and the generic principles defined herein might be applied to other embodiments and applications without departing from the spirit and scope of the disclosure. Thus, this disclosure is not intended to be limited to the embodiments shown but is to be accorded the widest scope consistent with the principles and features disclosed herein. In this regard, certain embodiments within the disclosure might not show every benefit of the disclosure, considered broadly.

1. An amine composition, comprising:
a) an alkylated diamine;
b) a tertiary amine; and
c) a polyoxyalkyleneamine.

2. The amine composition according to claim 1, wherein the alkylated diamine includes one or more selected from a mono-alkylated isophorone diamine, a di-alkylated isophorone diamine, a mono-alkylated cyclohexyldiamine, a di-alkylated cyclohexyldiamine, a mono-alkylated alkylcyclohexyldiamine, a di-alkylated alkylcyclohexyldiamine, a mono-alkylated 4-4′-methylenebis(cyclohexylamine), a di-alkylated 4-4′-methylenebis(cyclohexylamine), a mono-alkylated xylylenediamine, a di-alkylated xylylenediamine, a mono-alkylated bis(aminomethyl)cyclohexane, or a di-alkylated bis(aminomethyl)cyclohexane.

3. The amine composition according to claim 1, wherein the tertiary amine includes a phenolic tertiary amine.

4. The amine composition according to claim 3, wherein the polyoxyalkyleneamine includes at least one amino-terminated polyoxyethylene, amino-terminated polyoxypropylene, or amino-terminated polyoxybutylene.

5. The amine composition according to claim 4, wherein the polyoxyalkyleneamine includes an amino-terminated polyoxypropylene.

6. The amine composition according to claim 5, wherein the polyoxyalkyleneamine includes 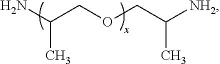
wherein x is an integer ranging from 2 to 70.

7. The amine composition according to claim 6, further comprising a cycloaliphatic amine.

8. The amine composition according to claim 7, wherein the cycloaliphatic amine includes one or more selected from the group consisting of isophorone diamine, methylcyclohexyldiamine, cyclohexyldiamine, 4,4′-methylenebis(cyclohexylamine), isomers of xylylenediamine, 1,2-bis aminomethylcyclohexane, 1,3-bis aminomethylcyclohexane, or 1,4-bis aminomethylcyclohexane

9. An epoxy system prepared from the amine composition according to claim 6 and an epoxy resin.

10. The epoxy system according to claim 9, wherein the epoxy resin includes one or more glycidyl ethers selected from the group of glycidyl ethers of: resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane, bis-(4-hydroxyphenyl)-methane, any of C12 to C14 alcohols, butanediol, hexanediol, polyoxypropylene glycol, and any combination thereof.

11. The epoxy system according to claim 9, wherein the amine composition has a weight percentage of 10% to 40%, and the epoxy resin has a weight percentage of 60% to 90%, based on a total weight of the epoxy system.

12. The epoxy system according to claim 11, further comprising one or more additives selected from the group consisting of fillers, reinforcing agents, coupling agents, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, adhesion promoters, anti-dripping agents, metallic pigments, stabilizers, metal glitters, metal coated particles, porosity inducers, plasticizers, glass fibers, nanoparticles, or flow assistants.

13. The epoxy system according to claim 10, wherein a stoichiometric ratio of the amine composition to the epoxy resin is 0.5 to 1.5, preferably 0.7 to 1.2, more preferably 0.8 to 1.0.

14. An article of manufacture comprising the epoxy system according to claim 12 wherein the article is selected from the group consistinq of structural or electrical laminates, coatings, castings, structural components, circuit boards, electrical varnishes, encapsulants, semiconductors, general molding powders, filament wound pipes and fittings, filament wound pressure vessels, low and high pressure pipes and fittings, low and high pressure vessels, storage tanks, wind turbine blades, automotive structural parts, aerospace structural parts, oil and gas buoyance modules, rigs, well plugs, cure-in-place-pipe (CIPP), structural bonding adhesives and laminates, a composite liner, liners for pumps, corrosion resistant coatings or composite materials based on reinforced fiber substrates.

15. An epoxy system prepared from the amine composition according to claim 8 and an epoxy resin.

16. The epoxy system according to claim 15, wherein the epoxy resin includes one or more glycidyl ethers selected from the group of glycidyl ethers of: resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane, bis-(4-hydroxyphenyl)-methane, any of C12 to C14 alcohols, butanediol, hexanediol, polyoxypropylene glycol, and any combination thereof.

17. The epoxy system according to claim 16, wherein the amine composition has a weight percentage of 10% to 40%, and the epoxy resin has a weight percentage of 60% to 90%, based on a total weight of the epoxy system.

18. The epoxy system according to claim 17, further comprising one or more additives selected from the group consisting of fillers, reinforcing agents, coupling agents, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, adhesion promoters, anti-dripping agents, metallic pigments, stabilizers, metal glitters, metal coated particles, porosity inducers, plasticizers, glass fibers, nanoparticles, or flow assistants.

19. The epoxy system according to claim 16, wherein a stoichiometric ratio of the amine composition to the epoxy resin is 0.5 to 1.5, preferably 0.7 to 1.2, more preferably 0.8 to 1.0.

20. An article of manufacture comprising the epoxy system according to claim 18 wherein the article is selected from the group consisting of structural or electrical laminates, coatings, castings, structural components, circuit boards, electrical varnishes, encapsulants, semiconductors, general molding powders, filament wound pipes and fittings, filament wound pressure vessels, low and high pressure pipes and fittings, low and high pressure vessels, storage tanks, wind turbine blades, automotive structural parts, aerospace structural parts, oil and gas buoyance modules, rigs, well plugs, cure-in-place-pipe (CIPP), structural bonding adhesives and laminates, a composite liner, liners for pumps, corrosion resistant coatings or composite materials based on reinforced fiber substrates.
